(19) United States
(12) Patent Application Publication
(10) Pub. No.: US 2026/0253751 A1
(43) Pub. Date: Aug. 27, 2026

(54) BLANKET FOR FUSION REACTOR

(71) Applicant: Kyoto Fusioneering Ltd., Tokyo (JP)

(72) Inventor: Taishi SUGIYAMA, Kyoto (JP)

(21) Appl. No.: 19/647,855

(22) Filed: Apr. 14, 2026

Related U.S. Application Data
(63) Continuation of application No. PCT/JP2024/034930, filed on Sep. 30, 2024.

(30) Foreign Application Priority Data
Oct. 18, 2023 (JP) 2023-179354

(51) Int. Cl. G21B 1/13

(52) U.S. Cl. CPC G21B 1/13

(57) ABSTRACT

A blanket includes an outer wall including a front outer wall facing a fusion plasma, an inner wall provided inside the outer wall and including a front inner wall facing the front outer wall on a side opposite to the fusion plasma, an outer flow path formed between the outer wall and the inner wall and through which a first fluid flows, and an inner flow path formed inside the inner wall and through which a second fluid identical to the first fluid flows.

The contents of the following patent application(s) are incorporated herein by reference:

2023-179354 filed in JP on October 18, 2023

PCT/JP2024/034930 filed in WO on September 30, 2024

### BACKGROUND

### 1. Technical Field

The present disclosure relates to a blanket for a fusion reactor.

### 2. Related Art

A fusion reactor causes a nuclear fusion reaction by turning fuel into plasma in a vacuum vessel. A blanket for protecting the inner surface of the vacuum vessel from plasma is provided on the inner surface of the vacuum vessel. The blanket may further have a fuel generation function of generating fuel by using neutrons generated by the nuclear fusion reaction, and a heat exchange function of extracting heat generated by the nuclear fusion reaction to the outside. For example, the blanket structure has been proposed that includes a housing containing a raw material including lithium for generating tritium as fuel, and a cooling flow path for recovering heat by causing a coolant to flow around the housing.

### Related Art Documents

### Patent Document

Patent Document 1: Japanese Patent Application Publication No. 2018-124178.

### BRIEF DESCRIPTION OF THE DRAWINGS

FIG. 1 is a diagram schematically illustrating the configuration of a fusion reactor according to an embodiment.

FIG. 2 is a diagram schematically illustrating a configuration of a blanket according to an embodiment.

FIG. 3 is a diagram schematically illustrating a flow path configuration of a fluid outside a vacuum vessel.

FIG. 4 is a diagram schematically illustrating another flow path configuration of the fluid outside a vacuum vessel.

FIG. 5 is a diagram schematically illustrating the configuration of a blanket according to another embodiment.

FIG. 6 is the external perspective view of the blanket according to one embodiment.

FIG. 7A is a side view of the blanket illustrated in FIG. 6.

FIG. 7B is the side view of the blanket illustrated in FIG. 6.

FIG. 8A is the cross-sectional view taken along line A-A illustrated in FIG. 7A.

FIG. 8B is the cross-sectional view taken along line B-B illustrated in FIG. 7B.

FIG. 8C is the cross-sectional view taken along line C-C illustrated in FIG. 7A.

FIG. 8D is the cross-sectional view taken along line D-D illustrated in FIG. 7B.

FIG. 8E is the cross-sectional view taken along line E-E illustrated in FIG. 7A.

FIG. 8F is the cross-sectional view taken along line F-F illustrated in FIG. 7B.

FIG. 8G is the cross-sectional view taken along line G-G illustrated in FIG. 7A.

### DESCRIPTION OF EXEMPLARY EMBODIMENTS

Hereinafter, embodiments for carrying out the present invention will be described in detail. The configurations described below are illustrative and do not limit the scope of the present invention in any way. In the description of the drawings, the same reference signs and numerals are assigned to the same elements, and redundant description is omitted as appropriate. In the drawings referred to in the following description, the sizes and thicknesses of the respective constituent members are for convenience of description and do not necessarily indicate the actual dimensions or ratios.

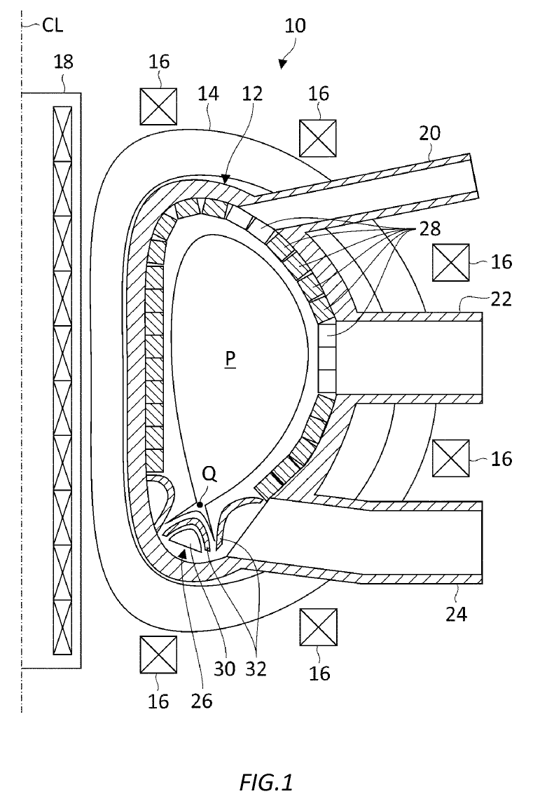

FIG. 1 is a diagram schematically illustrating the configuration of the fusion reactor 10 according to an embodiment. The fusion reactor 10 illustrated in FIG. 1 is of the type that confines fusion plasma P using the magnetic field, and is particularly a tokamak-type device. The fusion reactor 10 has the structure extending in a donut shape around the central axis CL.

In the present disclosure, a direction in which the central axis CL extends may be referred to as the axial direction, a direction away from the central axis CL may be referred to as the radial direction, and a direction orthogonal to the axial direction and the radial direction may be referred to as a circumferential direction. FIG. 1 shows the cross-sectional view orthogonal to the circumferential direction.

The fusion reactor 10 includes the vacuum vessel 12, the toroidal coil 14, the poloidal coil 16, and the center solenoid coil 18.

The vacuum vessel 12 accommodates the fusion plasma P. The vacuum vessel 12 has the D-shaped cross-sectional shape orthogonal to the circumferential direction. The vacuum vessel 12 surrounds the internal space extending in a donut shape in the circumferential direction. The vacuum vessel 12 can be made of a metal material such as stainless steel.

The toroidal coil 14, the poloidal coil 16, and the center solenoid coil 18 are, for example, superconducting coils, and generate the confinement magnetic field inside the vacuum vessel 12. The confinement magnetic field is the composite magnetic field obtained by combining magnetic fields generated by the toroidal coil 14, the poloidal coil 16, and the center solenoid coil 18, respectively.

The toroidal coil 14 extends in the D shape along an outer periphery of the vacuum vessel 12 in a cross-sectional view orthogonal to the circumferential direction. A plurality of the toroidal coils 14 are arranged at intervals in the circumferential direction. The poloidal coil 16 extends annularly in the circumferential direction around the central axis CL. The poloidal coil 16 is arranged radially outward of the vacuum vessel 12, and a plurality of the poloidal coils 16 are arranged at intervals in the axial direction. The center solenoid coil 18 is arranged radially inward of the vacuum vessel 12 and is arranged along the central axis CL.

The vacuum vessel 12 is provided with a plurality of ports such as the upper port 20, the central port 22, and the lower port 24. The upper port 20 is used, for example, to input the fuel into the vacuum vessel 12. As the fuel, for example, the mixed fuel containing deuterium (deuterium) and tritium (tritium) can be used. The central port 22 is used, for example, to input the energy for heating the fusion plasma P from outside. As energy for heating the fusion plasma P, for example, a high frequency wave output from the gyrotron (not illustrated) or a neutral particle beam output from a neutral particle beam device (not illustrated) can be used. The lower port 24 is used, for example, to discharge impurities such as helium generated by nuclear fusion and particle dust formed by particulate matter of the mixed fuel and the like.

A divertor 26 is provided in the lower portion of the vacuum vessel 12. The divertor 26 collects impurities and particle dust generated in the fusion plasma P, and discharges the impurities and the particle dust to the outside of the vacuum vessel 12 through the lower port 24. The divertor 26 is provided, for example, directly below the null point Q of the confinement magnetic field. The divertor 26 includes, for example, a discharge device 30 such as a diffusion pump or a cryopump for discharging impurities and particle dust, and a protection plate 32 such as the divertor plate for protecting the discharge device 30 from the fusion plasma P.

A plurality of blankets 28 are provided on the inner surface of the vacuum vessel 12. The plurality of blankets 28 are provided to protect the vacuum vessel 12 from the fusion plasma P. The plurality of blankets 28 are provided so as to cover, without gaps, portions where the inner surface of the vacuum vessel 12 can be exposed to the fusion plasma P.

The blanket 28 includes at least one of the heat exchange function, the fuel generation function, or the shielding function. The heat exchange function is a function of extracting thermal energy to an outside of the vacuum vessel 12 by using the coolant flowing inside the blanket 28. The fuel generation function is a function of arranging, inside the blanket 28, a raw material for generating fuel and generating fuel from the raw material by nuclear transmutation using neutrons generated in the fusion plasma P. The shielding function is a function of shielding neutrons and gamma rays generated in the fusion plasma P so as to prevent them from leaking to an outside of the vacuum vessel 12.

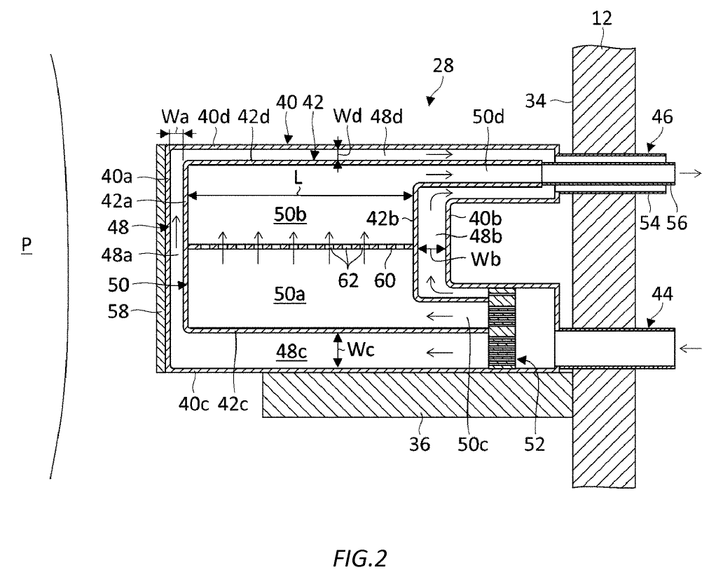

From the viewpoint of efficiently utilizing thermal energy extracted from the fusion reactor 10, it is preferable that the temperature of the fluid discharged from the blanket 28 be as high as possible. On the other hand, from the viewpoint of protecting the inner surface of the vacuum vessel 12 from plasma, it is preferable that the temperature of the fluid flowing through the blanket 28 be as low as possible. Therefore, in the blanket 28 according to the embodiment, there is provided the blanket for the fusion reactor that can extract high-temperature fluid while protecting the inner surface of the vacuum vessel from the fusion plasma P. FIG. 2 is a diagram schematically illustrating the configuration of the blanket 28 according to the embodiment. The blanket 28 is the blanket for the fusion reactor arranged inside the vacuum vessel 12 of the fusion reactor 10 illustrated in FIG. 1. FIG. 2 illustrates the cross-sectional view orthogonal to the circumferential direction.

The blanket 28 includes the outer wall 40, the inner wall 42, the supply pipe 44, and the discharge pipe 46. The blanket 28 includes the outer flow path 48 formed between the outer wall 40 and the inner wall 42, the inner flow path 50 formed inside the inner wall 42, and a flow divider 52. The fluid supplied from the supply pipe 44 is divided by the flow divider 52 into each of the outer flow path 48 and the inner flow path 50. The fluid that has passed through the outer flow path 48 or the inner flow path 50 is discharged to the outside from the discharge pipe 46. In FIG. 2, the flow of the fluid is schematically illustrated by arrows.

The fluid supplied from the supply pipe 44 is the coolant for cooling the blanket 28 and extracting thermal energy from the blanket 28 to the outside. When the blanket 28 has the fuel generation function, the coolant containing lithium, which is a raw material for generating tritium as fuel, can be used. The fluid in this case may be a liquid metal containing lithium, such as liquid lithium or liquid lithium lead, or may be a molten salt containing lithium, such as lithium beryllium fluoride (FLiBe). When the blanket 28 does not have the fuel generation function, the fluid not containing lithium, such as helium or carbon dioxide, may be used.

The fluid flowing through the outer flow path 48 or the inner flow path 50 functions as the coolant for cooling the blanket 28. The temperature of the fluid supplied from the supply pipe 44 is, for example, about 300°C to 400°C. The first fluid flowing through the outer flow path 48 is heated to, for example, about 500°C to 600°C, and then is discharged to the outside from the discharge pipe 46. The second fluid flowing through the inner flow path 50 is heated to, for example, about 900°C to 1000°C, and then is discharged to the outside from the discharge pipe 46. The temperature difference between the first fluid and the second fluid discharged from the discharge pipe 46 is, for example, 100°C or more, 200°C or more, 300°C or more, or 400°C or more.

The discharge pipe 46 includes the outer pipe 54 through which the first fluid discharged from the outer flow path 48 flows, and the inner pipe 56 through which the second fluid discharged from the inner flow path 50 flows. The discharge pipe 46 is a double pipe, and can be referred to as a double discharge pipe. By using the double discharge pipe, the first fluid and the second fluid having different temperatures can be separately discharged without being mixed. As a result, the high-temperature second fluid at for example, about 900°C to 1000°C can be extracted to the outside. Further, by causing the low-temperature first fluid to flow outside the inner pipe 56 through which the high-temperature second fluid flows, the structure such as the vacuum vessel 12 can be thermally protected from the high-temperature second fluid.

The outer wall 40 constitutes the housing that accommodates the outer flow path 48 and the inner flow path 50 therein. The outer wall 40 has, for example, the rectangular parallelepiped box shape. The outer wall 40 includes the front outer wall 40a, the rear outer wall 40b, the first side outer wall 40c, and the second side outer wall 40d. The front outer wall 40a is the first wall facing the fusion plasma P. The rear outer wall 40b is located on the opposite side of the front outer wall 40a with the outer flow path 48 and the inner flow path 50 interposed therebetween. The rear outer wall 40b faces, for example, the inner surface 34 of the vacuum vessel 12. The supply pipe 44 and the discharge pipe 46 are attached to the rear outer wall 40b. The rear outer wall 40b can be formed so as to extend in a C-shape or a U-shape from the supply pipe 44 toward the discharge pipe 46 in the cross-sectional view of FIG. 2. The first side outer wall 40c and the second side outer wall 40d extend toward the rear outer wall 40b in the direction away from the front outer wall 40a. The first side outer wall 40c extends from the front outer wall 40a toward the supply pipe 44. The second side outer wall 40d extends from the front outer wall 40a toward the discharge pipe 46.

The inner wall 42 is provided inside the outer wall 40. The inner wall 42 is the partition wall that serves as a partition between the outer flow path 48 and the inner flow path 50. The inner wall 42 can also be referred to as the container that accommodates the inner flow path 50. The inner wall 42 may be configured to have a double structure, and may have a structure in which the outer inner wall adjacent to the outer flow path 48 and the inner inner wall adjacent to the inner flow path 50 are laminated.

The inner wall 42 includes the front inner wall 42a, the rear inner wall 42b, the first side inner wall 42c, and the second side inner wall 42d. The front inner wall 42a faces the front outer wall 40a. The rear inner wall 42b faces the rear outer wall 40b. The rear inner wall 42b can be formed so as to extend in a C-shape or a U-shape from the flow divider 52 toward the discharge pipe 46 in the cross-sectional view of FIG. 2. The first side inner wall 42c faces the first side outer wall 40c. The second side inner wall 42d faces the second side outer wall 40d.

The outer wall 40 and the inner wall 42 are made of the material having excellent heat resistance that can withstand a high temperature of about 1000°C. The outer wall 40 and the inner wall 42 include, for example, silicon carbide (SiC), and are made of, for example, the SiC composite material. As the SiC composite material, for example, the SiC fiber-reinforced SiC composite material (SiCf/SiC) can be used. The outer wall 40 and the inner wall 42 may be made of the high-melting-point metal material such as tungsten.

The protective layer 58 for protecting the surface from the fusion plasma P may be provided on the front outer wall 40a. The protective layer 58 can be made of the high-melting-point metal material such as tungsten, the graphite material such as a carbon fiber-reinforced carbon composite material (CFC), or beryllium. In this case, the protective layer 58 functions as the first wall against the fusion plasma P. The protective layer 58 is not an essential configuration, and the front outer wall 40a may function as the first wall.

The outer flow path 48 includes the front outer flow path 48a, the rear outer flow path 48b, the outer inflow path 48c, and the outer outflow path 48d. The front outer flow path 48a is formed between the front outer wall 40a and the front inner wall 42a. The rear outer flow path 48b is formed between the rear outer wall 40b and the rear inner wall 42b. The outer inflow path 48c is formed between the first side outer wall 40c and the first side inner wall 42c. The outer outflow path 48d is formed between the second side outer wall 40d and the second side inner wall 42d.

The outer flow path 48 has a plurality of flow paths from the flow divider 52 toward the discharge pipe 46. The outer flow path 48 has a first outer flow path and a second outer flow path. The first outer flow path is the flow path that sequentially passes through the outer inflow path 48c, the front outer flow path 48a, and the outer outflow path 48d, and constitutes a C-shaped or U-shaped flow path from the flow divider 52 toward the discharge pipe 46. The second outer flow path is the flow path that passes through the rear outer flow path 48b, and constitutes a C-shaped or U-shaped flow path from the flow divider 52 toward the discharge pipe 46.

The main purpose of the first outer flow path is to cool the front outer wall 40a which is surface-heated by the fusion plasma P. In order to efficiently cool the front outer wall 40a, the flow path width Wa of the front outer flow path 48a can be set to be relatively small. Thus, the flow velocity of the first fluid in the front outer flow path 48a is increased, and the cooling efficiency of the front outer wall 40a can be improved. The flow path width Wa of the front outer flow path 48a can be set to, for example, not less than 1 mm, not less than 3 mm, or not less than 5 mm, and can be set to, for example, not more than 20 mm, not more than 15 mm, or not more than 10 mm.

Further, in order to increase the flow rate of the first fluid in the front outer flow path 48a, the flow path width Wc of the outer inflow path 48c can be set relatively large. By increasing the flow rate of the first fluid, cooling efficiency of the front outer wall 40a can be improved. The flow path width Wc of the outer inflow path 48c can be set to, for example, not less than 5 mm, not less than 10 mm, or not less than 20 mm, and can be set to, for example, not more than 50 mm, not more than 40 mm, or not more than 30 mm. Accordingly, the flow path cross-sectional area of the front outer flow path 48a can be made smaller than the flow path cross-sectional area of the outer inflow path 48c.

The relatively high-temperature first fluid heated in the front outer flow path 48a flows through the outer outflow path 48d. In order to suppress heating of the first fluid in the outer outflow path 48d, the flow path width Wd of the outer outflow path 48d can be set relatively small. Thus, the flow velocity of the first fluid in the outer outflow path 48d is increased, and the temperature rise of the first fluid toward the discharge pipe 46 can be suppressed. The flow path width Wd of the outer outflow path 48d can be set to, for example, not less than 1 mm, not less than 3 mm, or not less than 5 mm, and can be set to, for example, not more than 20 mm, not more than 15 mm, or not more than 10 mm. Accordingly, the flow path cross-sectional area of the outer outflow path 48d can be made smaller than the flow path cross-sectional area of the outer inflow path 48c. Note that the flow path cross-sectional area of the outer outflow path 48d may be equivalent to, may be smaller than, or may be larger than the flow path cross-sectional area of the front outer flow path 48a.

The main purpose of the rear outer flow path 48b, which is the second outer flow path, is to shield radiant heat from a high-temperature second fluid flowing through the inner flow path 50. Since the first fluid flowing through the rear outer flow path 48b is relatively low in temperature, the vacuum vessel 12 can be thermally protected by the first fluid flowing through the rear outer flow path 48b. The flow path width Wb of the rear outer flow path 48b can be set to the size that can shield radiant heat. The flow path width Wb of the rear outer flow path 48b can be set to, for example, not less than 5 mm, not less than 10 mm, or not less than 20 mm, and can be set to, for example, not more than 50 mm, not more than 40 mm, or not more than 30 mm.

The flow path width Wb of the rear outer flow path 48b is, for example, larger than the flow path width Wa of the front outer flow path 48a, and is, for example, larger than the flow path width Wd of the outer outflow path 48d. Accordingly, the flow path cross-sectional area of the rear outer flow path 48b can be made larger than the flow path cross-sectional area of the front outer flow path 48a or the outer outflow path 48d. The flow path width Wb of the rear outer flow path 48b may be equivalent to, may be smaller than, or may be larger than the flow path width Wc of the outer inflow path 48c. Accordingly, the flow path cross-sectional area of the rear outer flow path 48b may be equivalent to, may be smaller than, or may be larger than the flow path cross-sectional area of the outer inflow path 48c. Note that the blanket 28 may include the front outer flow path 48a, the outer inflow path 48c, the outer outflow path 48d, and the inner flow path 50, and may not include the rear outer flow path 48b.

The inner flow path 50 includes the first heating chamber 50a, the second heating chamber 50b, the inner inflow path 50c, and the inner outflow path 50d. The first heating chamber 50a and the second heating chamber 50b are formed between the front inner wall 42a and the rear inner wall 42b. The inner inflow path 50c is formed between the rear inner wall 42b and the first side inner wall 42c. The inner outflow path 50d is formed between the rear inner wall 42b and the second side inner wall 42d.

The reinforcing wall 60 is provided between the first heating chamber 50a and the second heating chamber 50b. The reinforcing wall 60 has a plurality of flow holes 62 for allowing the second fluid to pass therethrough. The reinforcing wall 60 extends from the front inner wall 42a toward the rear inner wall 42b. Note that the reinforcing wall 60 is not an essential configuration, and the reinforcing wall 60 may not be provided. In this case, the single heating chamber occupying the first heating chamber 50a and the second heating chamber 50b may be provided. In addition, the plurality of reinforcing walls may be provided between the front inner wall 42a and the rear inner wall 42b, and the plurality of reinforcing walls may be arranged at intervals in a direction from the first side inner wall 42c toward the second side inner wall 42d. In this case, three or more heating chambers partitioned by the plurality of reinforcing walls may be provided.

The inner flow path 50 constitutes the C-shaped or U-shaped flow path that sequentially passes through the inner inflow path 50c, the first heating chamber 50a, the second heating chamber 50b, and the inner outflow path 50d from the flow divider 52 toward the discharge pipe 46. The second fluid flowing through the inner flow path 50 is volumetrically heated by the nuclear reaction with neutrons from the fusion plasma P and collision energy of the neutrons. The first heating chamber 50a and the second heating chamber 50b have relatively large volumes in order to increase the thermal energy obtained by volumetric heating. The volume occupied by the first heating chamber 50a and the second heating chamber 50b is preferably, for example, 30% or more, 40% or more, 50% or more, or 60% or more of the total volume of the blanket 28. The volume of the inner flow path 50 is preferably larger than the volume of the outer flow path 48.

The flow path cross-sectional areas of the first heating chamber 50a and the second heating chamber 50b are preferably larger than the flow path cross-sectional areas of the inner inflow path 50c and the inner outflow path 50d. This makes it possible to relatively reduce the flow velocity of the second fluid flowing through the first heating chamber 50a and the second heating chamber 50b. The first heating chamber 50a and the second heating chamber 50b are located closer to the fusion plasma P than the inner inflow path 50c and the inner outflow path 50d, and thus receive a larger amount of neutrons from the fusion plasma P, and also have larger thermal energy of volumetric heating. By reducing the flow velocity of the second fluid in the first heating chamber 50a and the second heating chamber 50b, which are easily volumetrically heated, the second fluid can be efficiently heated. As a result, the temperature of the second fluid discharged from the second heating chamber 50b can be the high temperature of about 900°C to 1000°C.

By increasing the radial sizes of the first heating chamber 50a and the second heating chamber 50b, that is, by increasing the distance L from the front inner wall 42a to the rear inner wall 42b, the shielding function of the blanket 28 can be improved. The distance L from the front inner wall 42a to the rear inner wall 42b can be, for example, 300 mm or more, 400 mm or more, 500 mm or more, or 700 mm or more.

The flow divider 52 divides the fluid supplied from the supply pipe 44 into the first fluid directed to the outer flow path 48 and the second fluid directed to the inner flow path 50. The flow divider 52 is configured to divide the flow, for example, such that the flow rate of the first fluid becomes larger than the flow rate of the second fluid. By relatively increasing the flow rate of the first fluid, the outer wall 40 can be efficiently cooled. By relatively reducing the flow rate of the second fluid, the flow velocity of the second fluid can be reduced, and the second fluid can be heated to a higher temperature by volumetric heating.

The flow divider 52 can set the flow rate ratio of the first fluid to, for example, 50% or more and 80% or less, for example, 60% or more and 70% or less. The flow divider 52 can set the flow rate ratio of the second fluid to, for example, 20% or more and 50% or less, for example, 30% or more and 40% or less. The flow divider 52 has a plurality of flow holes through which the fluid is allowed to pass to the outer flow path 48 or the inner flow path 50. By adjusting the positions, sizes, numbers, and the like of the plurality of flow holes of the flow divider 52, it is possible to set, to a desired value, the flow rate ratio of the fluid distributed to each of the outer flow path 48 and the inner flow path 50.

The flow divider 52 further distributes, as the first fluid directed to the outer flow path 48, the fluid into the fluid directed to the outer inflow path 48c and the fluid directed to the rear outer flow path 48b. The flow rate of the fluid directed to the outer inflow path 48c is greater than the flow rate of the fluid directed to the rear outer flow path 48b. By relatively increasing the flow rate of the fluid directed to the outer inflow path 48c, it is possible to efficiently cool the front outer wall 40a, which is greatly surface-heated by the fusion plasma P. The flow rate of the fluid directed to the outer inflow path 48c can be set to be not less than two times, not less than three times, not less than five times, or not less than seven times the flow rate of the fluid directed to the rear outer flow path 48b. As an example, when the flow rate of the fluid supplied from the supply pipe 44 is 100%, the flow rate of the fluid directed to the outer inflow path 48c is not less than 40% and not more than 70%, for example, not less than 50% and not more than 60%, and the flow rate of the fluid directed to the rear outer flow path 48b is not less than 1% and not more than 20%, for example, not less than 5% and not more than 15%.

The blanket 28 can be supported by the support structure 36 provided on the inner surface 34 of the vacuum vessel 12. The support structure 36 can support, for example, the first side outer wall 40c. In the outer inflow path 48c adjacent to the first side outer wall 40c, the low-temperature first fluid immediately after being supplied from the supply pipe 44 flows. Therefore, the temperature of the first side outer wall 40c is lower than those of the front outer wall 40a and the second side outer wall 40d, and is maintained at, for example, the temperature of not more than 500°C or not more than 400°C. As a result, it is possible to suppress the temperature rise of the support structure 36 adjacent to the first side outer wall 40c, and the support structure 36 can be constructed using a material having low heat resistance. For example, stainless steel, concrete, or the like can be used as a material of the support structure 36.

Next, the operation of the blanket 28 will be described. The fluid supplied from the supply pipe 44 is divided by the flow divider 52 into the first fluid directed to the outer flow path 48 and the second fluid directed to the inner flow path 50. Since the first fluid flowing through the outer flow path 48 has a high flow velocity, the outer wall 40 of the blanket 28 can be efficiently cooled. Since the second fluid flowing through the inner flow path 50 has a low flow velocity, the second fluid is efficiently volumetrically heated in the interior of the blanket 28 and becomes high in temperature. The relatively low-temperature first fluid is discharged through the outer pipe 54 of the discharge pipe 46 that is a double pipe. The relatively high-temperature second fluid is discharged through the inner pipe 56. Since the second fluid having a relatively high temperature passes through the inside of the double pipe, the second fluid can be discharged to the outside while being maintained at a high temperature. In addition, since the relatively low-temperature first fluid passes through the outside of the double pipe, radiant heat from the high-temperature second fluid can be shielded by the first fluid. As a result, it is possible to suppress thermal influence on the structure that supports the discharge pipe 46, such as the vacuum vessel 12.

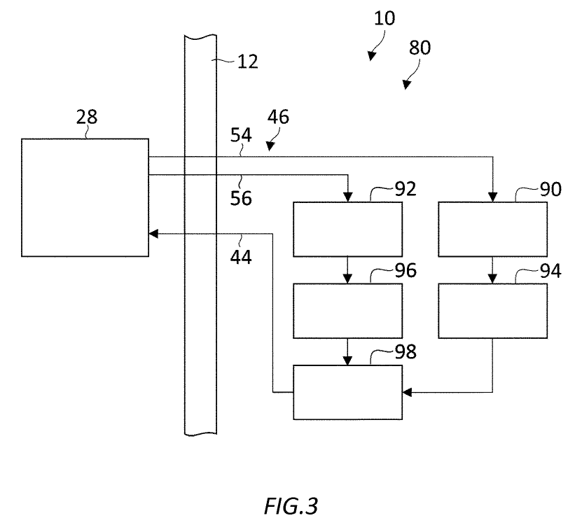

FIG. 3 is a diagram schematically illustrating the flow path configuration of the fluid outside the vacuum vessel 12. Outside the vacuum vessel 12, the first heat exchanger 90, the second heat exchanger 92, the first fuel separation device 94, the second fuel separation device 96, and the pump 98 are provided. The first fluid discharged through the outer pipe 54 of the discharge pipe 46 is sent to the first heat exchanger 90, and thermal energy is extracted at the first heat exchanger 90. The second fluid discharged through the inner pipe 56 of the discharge pipe 46 is sent to the second heat exchanger 92, and thermal energy is extracted at the second heat exchanger 92. By sending the first fluid and the second fluid having different temperatures, respectively to the first heat exchanger 90 and the second heat exchanger 92, thermal energy can be efficiently extracted. In particular, by setting the temperature of the second fluid to about 900°C to 1000°C, the utilization efficiency of thermal energy can be improved. The thermal energy extracted by the first heat exchanger 90 and the second heat exchanger 92 can be used for power generation and the like.

The first fluid from which thermal energy has been extracted by the first heat exchanger 90 is sent to the first fuel separation device 94, and tritium as fuel is extracted by the first fuel separation device 94. The second fluid from which thermal energy has been extracted by the second heat exchanger 92 is sent to the second fuel separation device 96, and tritium as fuel is extracted by the second fuel separation device 96. As the first fuel separation device 94 and the second fuel separation device 96, for example, the VST (Vacuum Sieve Tray) can be used. When the content ratio of fuel contained in each of the first fluid and the second fluid is different, by using separate fuel separation devices, the extraction efficiency of fuel can be improved. Note that fuel may be extracted from only one of the first fluid or the second fluid. For example, when the fuel content ratio of the second fluid is greater than the fuel content ratio of the first fluid, only the second fuel separation device 96 may be used, and the first fuel separation device 94 may not be used. Further, when the blanket 28 does not have the fuel generation function, the first fuel separation device 94 and the second fuel separation device 96 may not be provided.

The first fluid and the second fluid from which fuel has been separated by the first fuel separation device 94 and the second fuel separation device 96 are sent to the blanket 28 by the pump 98. Accordingly, after thermal energy and fuel are extracted, the first fluid and the second fluid are reused as fluids supplied from the supply pipe 44 into the interior of the blanket 28.

The blanket 28, the first heat exchanger 90, and the second heat exchanger 92 can constitute the heat exchange system 80 of the fusion reactor 10. The heat exchange system 80 includes the blanket 28, the first heat exchanger 90, and the second heat exchanger 92. The heat exchange system 80 can further include at least one of the first fuel separation device 94 or the second fuel separation device 96. The heat exchange system 80 can further include the pump 98.

According to the flow path configuration of FIG. 3, the high-temperature second fluid can be extracted from the blanket 28, and thermal energy can be efficiently extracted from the fluid heated by the blanket 28. When the blanket 28 has a fuel generation function, by extracting the first fluid and the second fluid separately, fuel can be efficiently extracted from the fluid having the high fuel content ratio. According to the present embodiment, since the outer wall 40 and the discharge pipe 46 of the blanket 28 can be maintained at a relatively low temperature by the first fluid, thermal influence on the vacuum vessel 12 and the support structure 36 can be suppressed.

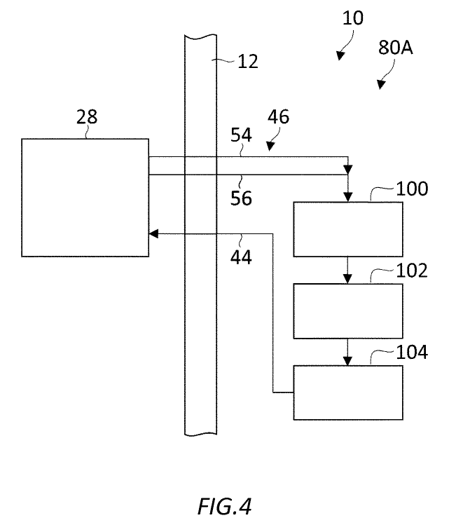

FIG. 4 is a diagram schematically illustrating another flow path configuration of the fluid outside the vacuum vessel 12. The flow path configuration of FIG. 4 differs from the flow path configuration of FIG. 3 in that a mixed fluid in which the first fluid and the second fluid are mixed is input to the heat exchanger 100. In the configuration example of FIG. 4, the heat exchanger 100, the fuel separation device 102, and the pump 104 are provided outside the vacuum vessel 12. The first fluid discharged through the outer pipe 54 of the discharge pipe 46 is mixed, outside the vacuum vessel 12, with the second fluid discharged through the inner pipe 56 of the discharge pipe 46. The mixed fluid in which the first fluid and the second fluid are mixed is sent to the heat exchanger 100, and thermal energy is extracted by the heat exchanger 100. The mixed fluid from which thermal energy has been extracted by the heat exchanger 100 is sent to the fuel separation device 102, and tritium as fuel is extracted by the fuel separation device 102. The mixed fluid from which fuel has been separated by the fuel separation device 102 is sent to the blanket 28 by the pump 104.

According to the flow path configuration of FIG. 4, the flow path configuration outside the vacuum vessel 12 can be simplified as compared with the flow path configuration of FIG. 3. Also in the flow path configuration of FIG. 4, since the discharge pipe 46 penetrating the wall of the vacuum vessel 12 is a double pipe, thermal influence on the structure such as the vacuum vessel 12 supporting the discharge pipe 46 can be suppressed. Further, even when the first fluid and the second fluid are mixed, the temperature of the mixed fluid can be made higher than the temperature of the first fluid as compared with the case where only the relatively low-temperature first fluid is extracted. As a result, thermal energy can be efficiently extracted in the heat exchanger 100.

The blanket 28 and the heat exchanger 100 constitute the heat exchange system 80A of the fusion reactor 10. The heat exchange system 80A includes the blanket 28 and the heat exchanger 100. The heat exchange system 80A can further include the fuel separation device 102. The heat exchange system 80A can further include the pump 104.

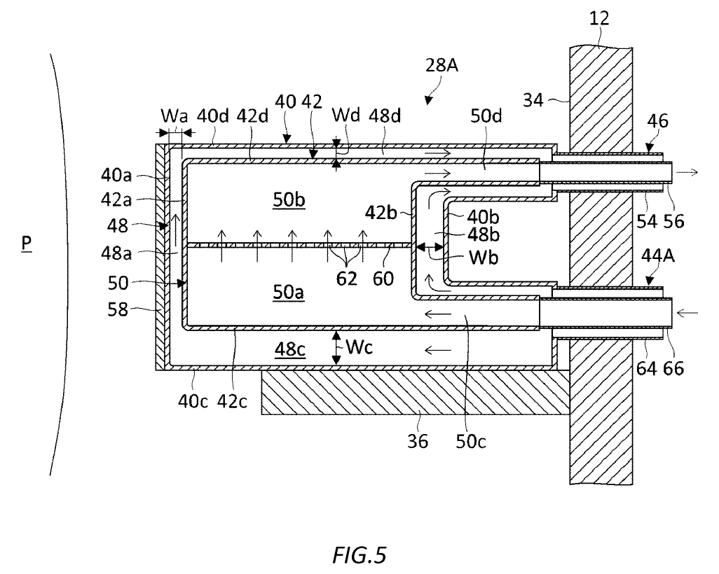

FIG. 5 is a diagram schematically illustrating the configuration of the blanket 28A according to another embodiment. The blanket 28A illustrated in FIG. 5 differs from the above-described embodiment in that the supply pipe 44A is a double pipe. Hereinafter, another embodiment will be described mainly focusing on differences from the above-described embodiment, and description of common points will be omitted as appropriate.

The blanket 28A includes the outer wall 40, the inner wall 42, the supply pipe 44A, and the discharge pipe 46. The blanket 28A includes the outer flow path 48 formed between the outer wall 40 and the inner wall 42, and the inner flow path 50 formed inside the inner wall 42. The outer wall 40, the inner wall 42, the discharge pipe 46, the outer flow path 48, and the inner flow path 50 can be configured similarly to the above-described embodiment.

The supply pipe 44A is the double pipe having an outer pipe 64 and an inner pipe 66, and can be referred to as the double supply pipe. The first fluid supplied to the outer flow path 48 flows through the outer pipe 64. The second fluid supplied to the inner flow path 50 flows through the inner pipe 66. The first fluid supplied from the outer pipe 64 goes, for example, toward the outer inflow path 48c that is a first outer flow path and toward the rear outer flow path 48b that is a second outer flow path. In the example illustrated in FIG. 5, the flow divider 52 according to the above-described embodiment is not provided. However, the flow divider may be provided at the branch point between the outer inflow path 48c and the rear outer flow path 48b. Note that the blanket 28A may include the front outer flow path 48a, the outer inflow path 48c, the outer outflow path 48d, and the inner flow path 50, and may not include the rear outer flow path 48b.

According to the present embodiment, different substances can be used separately as the first fluid and the second fluid. For example, while the coolant that does not include a raw material for generating fuel can be used as the first fluid, the coolant that includes a raw material for generating fuel can be used as the second fluid. For example, the first fluid can be helium or carbon dioxide, and the second fluid can be liquid lithium, liquid lithium lead, or lithium beryllium fluoride. Note that the first fluid and the second fluid may be the same substance.

Also in the present embodiment, effects similar to those of the embodiment illustrated in FIG. 2 can be achieved. According to the present embodiment, the first fluid and the second fluid can also be different substances, and substances suitable for the cooling function in the outer flow path 48 and the heating function in the inner flow path 50 can be selected. Further, the blanket 28A illustrated in FIG. 5 can be used in the heat exchange systems 80 and 80A illustrated in FIGS. 3 and 4. The heat exchange systems 80 and 80A may include the blanket 28A illustrated in FIG. 5.

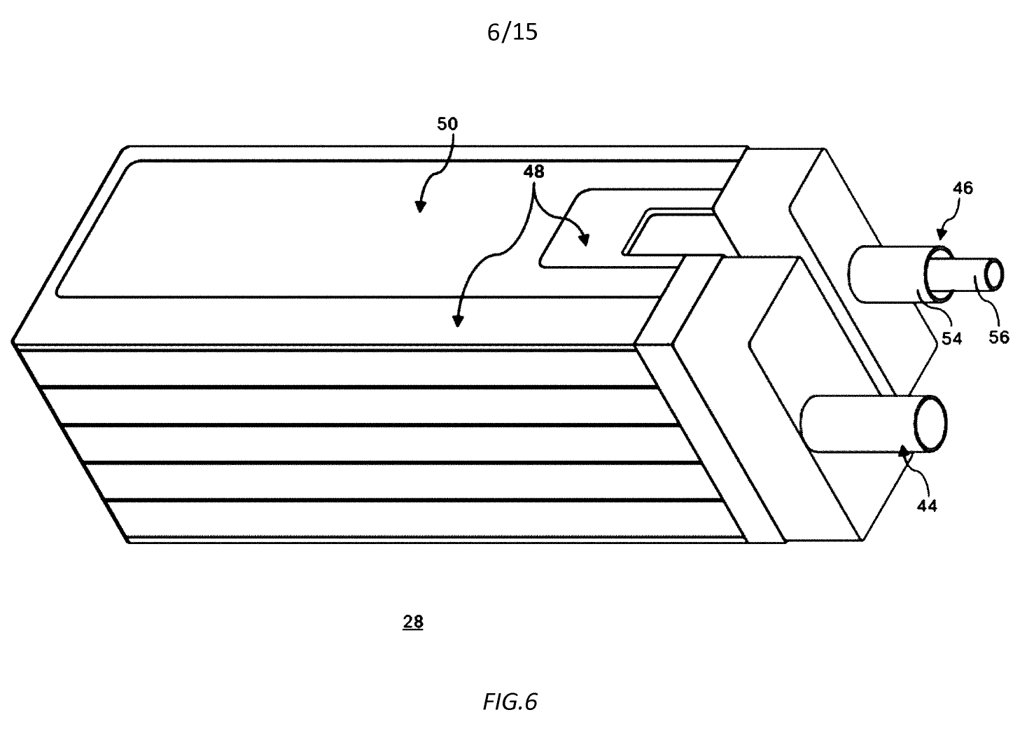

FIG. 6 is the external perspective view of the blanket 28 according to one embodiment. The blanket 28 includes the inner flow path 50 that forms a U-shaped flow path, and the outer flow path 48 that forms a U-shaped flow path arranged so as to surround the outside and the inside of the inner flow path 50. The blanket 28 further includes the supply pipe 44 that supplies a fluid to the outer flow path 48 and the inner flow path 50, the outer pipe 54 of the discharge pipe 46 that discharges the fluid from the outer flow path 48, and the inner pipe 56 of the discharge pipe 46 that discharges the fluid from the inner flow path 50.

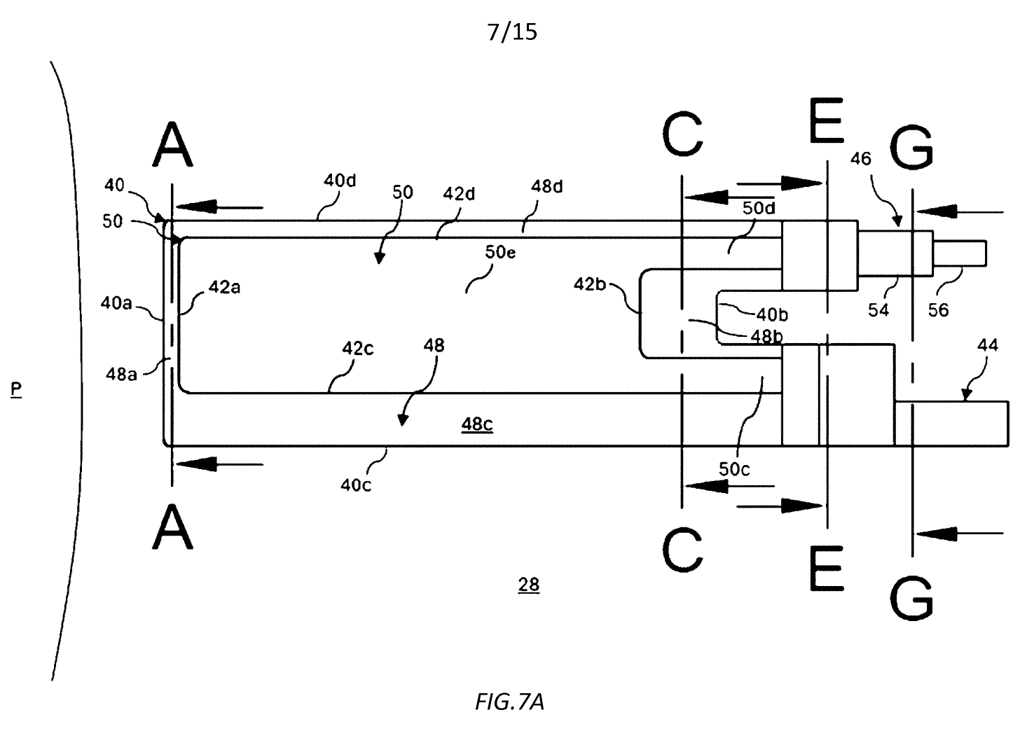

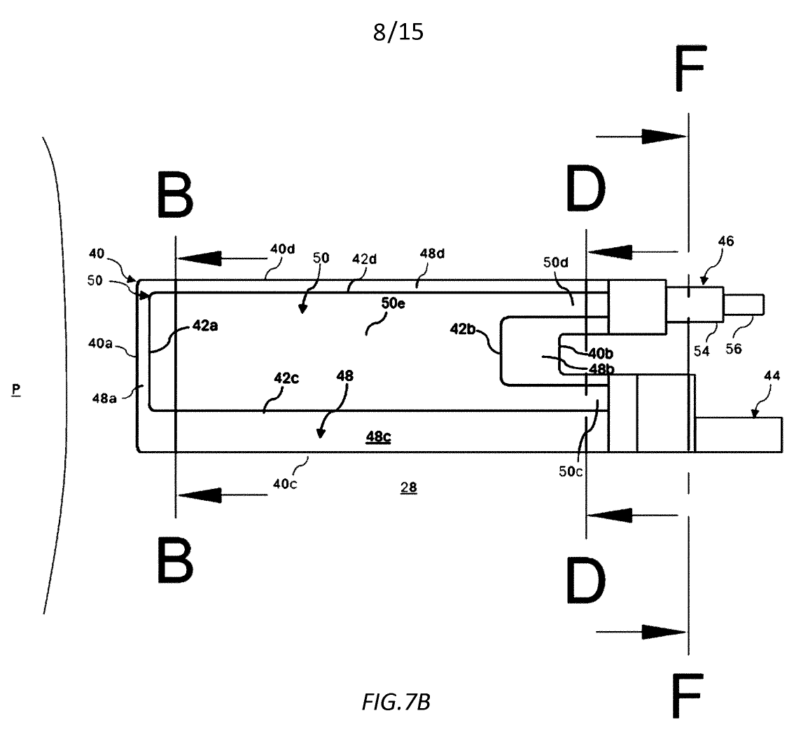

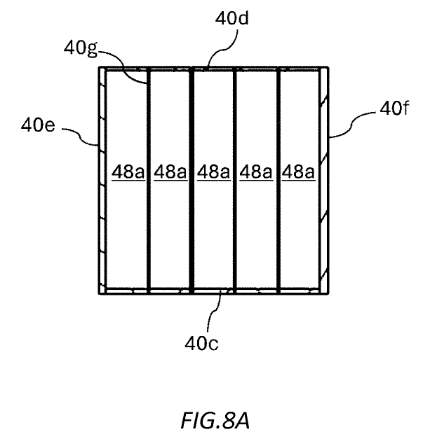

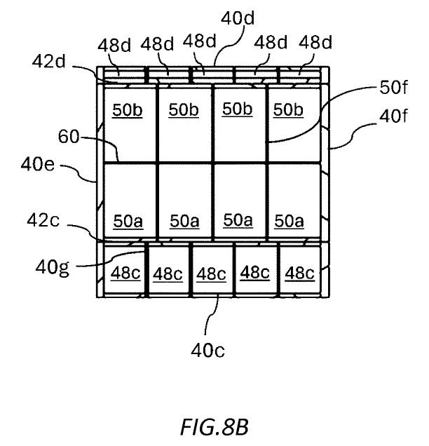

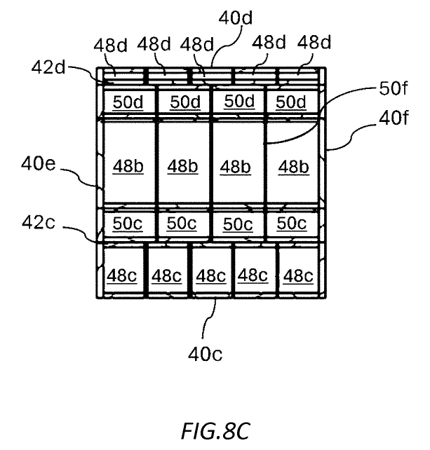

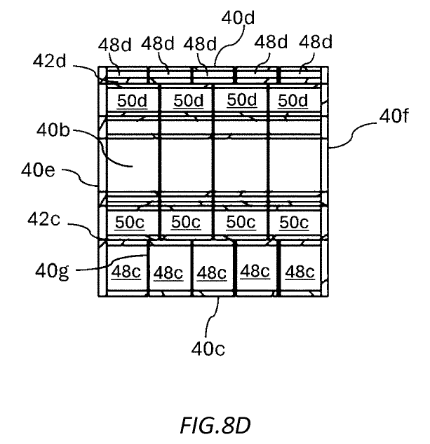

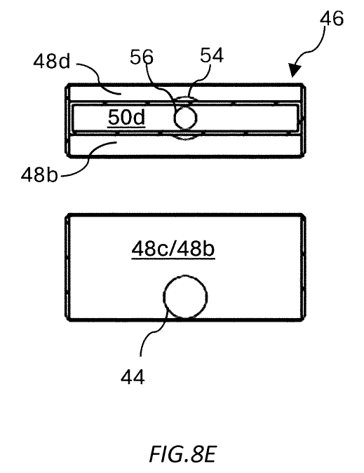

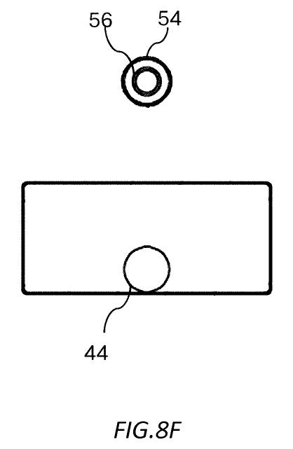

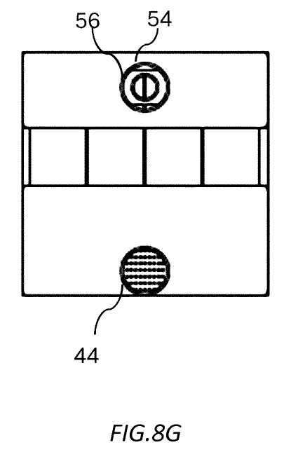

FIGS. 7A and 7B are side views of the blanket 28 illustrated in FIG. 6. FIG. 8A is the cross-sectional view taken along line A-A illustrated in FIG. 7A. FIG. 8B is the cross-sectional view taken along line B-B illustrated in FIG. 7B. FIG. 8C is the cross-sectional view taken along line C-C illustrated in FIG. 7A. FIG. 8D is the cross-sectional view taken along line D-D illustrated in FIG. 7B. FIG. 8E is the cross-sectional view taken along line E-E illustrated in FIG. 7A. FIG. 8F is the cross-sectional view taken along line F-F illustrated in FIG. 7B. FIG. 8G is the cross-sectional view taken along line G-G illustrated in FIG. 7A.

The blanket 28 has the outer wall 40 defining the outer flow path 48 and the inner wall 42 defining the inner flow path 50. The outer wall 40 includes the front outer wall 40a facing the fusion plasma P, and the first side outer wall 40c and the second side outer wall 40d extending in a direction away from the front outer wall 40a. The outer wall 40 further includes the third side outer wall 40e and the fourth side outer wall 40f that are arranged to face each other with the front outer wall 40a, the first side outer wall 40c, the second side outer wall 40d, the front inner wall 42a, the first side inner wall 42c, the second side inner wall 42d, and the rear inner wall 42b interposed therebetween.

The outer flow path 48 is formed between the outer wall 40 and the inner wall 42. The inner flow path 50 is formed inside the inner wall 42, and fluid flows therein. The outer flow path 48 includes the front outer flow path 48a in which a fluid flows along the front outer wall 40a. The outer flow path 48 includes the outer inflow path 48c in which the fluid flows along the first side outer wall 40c toward the front outer flow path 48a. The outer flow path 48 includes the outer outflow path 48d in which a fluid flows along the second side outer wall 40d from the front outer flow path 48a toward the discharge pipe 46 that is the double discharge pipe.

The inner wall 42 is provided inside the outer wall 40 and includes the front inner wall 42a that faces the front outer wall 40a on a side opposite to the fusion plasma P. The inner wall 42 includes the first side inner wall 42c and the second side inner wall 42d extending in directions away from the front inner wall 42a, and the rear inner wall 42b facing the front inner wall 42a on a side opposite to the front outer wall 40a. The outer wall 40 further includes the rear outer wall 40b facing, on a side opposite to the front inner wall 42a, the rear inner wall 42b. The outer flow path 48 further includes the rear outer flow path 48b in which a fluid flows along the rear outer wall 40b. Note that the blanket 28 may include the front outer flow path 48a, the outer inflow path 48c, the outer outflow path 48d, and the inner flow path 50, and may not include the rear outer flow path 48b.

The inner flow path 50 includes a front inner flow path 50e in which the fluid flows between the front inner wall 42a and the rear inner wall 42b, the inner inflow path 50c in which the fluid flows along the first side inner wall 42c toward the front inner flow path 50e, and the inner outflow path 50d in which the fluid flows along the second side inner wall 42d in a direction away from the front inner flow path 50e. The front inner flow path 50e is divided into the first heating chamber 50a and the second heating chamber 50b via the reinforcing wall 60.

The outer flow path 48 is divided into a plurality of flow paths via the outer partition wall 40g. Similarly, the inner flow path 50 is divided into a plurality of flow paths via the inner partition wall 50f. The outer partition wall 40g and the inner partition wall 50f are provided to reinforce the outer flow path 48 and the inner flow path 50. However, the blanket 28 may not include the outer partition wall 40g and the inner partition wall 50f.

The third side outer wall 40e and the fourth side outer wall 40f are connected to each of the front outer wall 40a, the first side outer wall 40c, the second side outer wall 40d, the front inner wall 42a, the first side inner wall 42c, the second side inner wall 42d, and the rear inner wall 42b.

A flow path cross-sectional area of the front outer flow path 48a is smaller than the flow path cross-sectional area of the outer inflow path 48c. A flow path cross-sectional area of the outer outflow path 48d is smaller than the flow path cross-sectional area of the outer inflow path 48c. A flow path cross-sectional area of the front outer flow path 48a is smaller than the flow path cross-sectional area of the front inner flow path 50e. With such a configuration, the fluid supplied from the supply pipe 44 is divided into a first fluid directed to the outer flow path 48 and a second fluid directed to the inner flow path 50. Since the first fluid flowing through the outer flow path 48 has a high flow velocity, the first fluid can efficiently cool the outer wall 40 of the blanket 28. Since the second fluid flowing through the inner flow path 50 has a low flow velocity, the second fluid is efficiently volumetrically heated in the interior of the blanket 28 and becomes high in temperature. The relatively low-temperature first fluid is discharged through the outer pipe 54 of the discharge pipe 46 that is the double pipe. The relatively high-temperature second fluid is discharged through the inner pipe 56. Since the second fluid having a relatively high temperature passes through the inside of the double pipe, the second fluid can be discharged to the outside while being maintained at a high temperature. Further, since the relatively low-temperature first fluid passes through the outside of the double pipe, transfer of heat from the high-temperature second fluid can be shielded by the first fluid. As a result, thermal influence on the structure supporting the discharge pipe 46, such as the vacuum vessel 12, can be suppressed.

The main purpose of the front outer flow path 48a is to cool the front outer wall 40a that is surface-heated by the fusion plasma P. In order to efficiently cool the front outer wall 40a, the flow path width of the front outer flow path 48a may be set to be relatively small. A flow path cross-sectional area of the front outer flow path 48a may be smaller than the flow path cross-sectional area of the outer inflow path 48c. This makes it possible to increase the flow velocity of the first fluid in the front outer flow path 48a and improve cooling efficiency of the front outer wall 40a.

Further, in order to increase the flow rate of the first fluid in the front outer flow path 48a, the flow path width of the outer inflow path 48c may be set relatively large. By increasing the flow rate of the first fluid, the cooling efficiency of the front outer wall 40a can be improved.

The relatively high-temperature first fluid heated in the front outer flow path 48a flows through the outer outflow path 48d. In order to suppress heating of the first fluid in the outer outflow path 48d, the flow path width of the outer outflow path 48d may be set relatively small. A flow path cross-sectional area of the outer outflow path 48d may be smaller than the flow path cross-sectional area of the outer inflow path 48c. This makes it possible to suppress heating of the first fluid in the outer outflow path 48d.

The above-described blanket 28 has been described as an embodiment including the outer pipe 54 and the inner pipe 56 as a discharge pipe. That is, the blanket 28 has been described as an example including double piping as the discharge pipe. However, the blanket 28 may not include double piping. For example, the blanket 28 may include only the outer pipe 54 and may not include the inner pipe 56.

The present disclosure has been described above based on embodiments. Various modifications are possible for combinations of respective constituent elements and respective processes in the exemplary embodiments, and it is obvious to those skilled in the art that such modifications are included in the scope of the present disclosure.

In the above-described embodiments, the blankets 28 and 28A applied to the tokamak-type fusion reactor 10 have been described. The type of fusion reactor to which the blankets 28 and 28A according to the present embodiments are applicable is not particularly limited, and the blankets 28 and 28A may be applied to the helical-type magnetic confinement fusion reactor, or may be applied to the inertial confinement fusion reactor such as the laser fusion reactor.

(Item 1)

A blanket for a fusion reactor comprising: an outer wall including a front outer wall facing a fusion plasma;

an inner wall provided inside the outer wall and including a front inner wall facing the front outer wall on a side opposite to the fusion plasma;

an outer flow path formed between the outer wall and the inner wall and through which a first fluid flows; and

an inner flow path formed inside the inner wall and through which a second fluid identical to the first fluid flows.

(Item 2)

The blanket for the fusion reactor according to item 1, further comprising: a double discharge pipe having an outer pipe through which the first fluid discharged from the outer flow path flows and an inner pipe through which the second fluid discharged from the inner flow path flows.

(Item 3)

A blanket for a fusion reactor comprising: an outer wall;

an inner wall provided inside the outer wall;

an outer flow path formed between the outer wall and the inner wall and through which a first fluid flows;

an inner flow path formed inside the inner wall and through which a second fluid flows; and

a double discharge pipe having an outer pipe through which the first fluid discharged from the outer flow path flows and an inner pipe through which the second fluid discharged from the inner flow path flows.

(Item 4)

The blanket for the fusion reactor according to item 2, wherein during operation of the fusion reactor, a temperature of the second fluid flowing through the double discharge pipe is higher than a temperature of the first fluid flowing through the double discharge pipe.

(Item 5)

The blanket for the fusion reactor according to item 1, wherein a volume of the inner flow path is larger than a volume of the outer flow path.

(Item 6)

The blanket for the fusion reactor according to item 1, further comprising: a supply pipe to which a fluid is supplied, and

a flow divider that divides the fluid supplied from the supply pipe into the first fluid toward the outer flow path and the second fluid toward the inner flow path.

(Item 7)

The blanket for the fusion reactor according to item 6, wherein the flow divider is configured to divide the fluid such that a flow rate of the first fluid becomes greater than a flow rate of the second fluid.

(Item 8)

The blanket for the fusion reactor according to item 6, wherein the fluid includes lithium.

(Item 9)

The blanket for the fusion reactor according to item 6, wherein the fluid is a liquid metal.

(Item 10)

The blanket for the fusion reactor according to item 1, wherein at least one of the outer wall or the inner wall includes silicon carbide.

(Item 11)

The blanket for the fusion reactor according to Item 1, wherein the outer wall further includes a first side outer wall and a second side outer wall extending in a direction away from the front outer wall, and

the outer flow path includes a front outer flow path through which the first fluid flows along the front outer wall, an outer inflow path through which the first fluid flows along the first side outer wall toward the front outer flow path, and an outer outflow path through which the first fluid flows along the second side outer wall in a direction away from the front outer flow path.

(Item 12)

The blanket for the fusion reactor according to Item 3, wherein the outer wall includes a front outer wall facing a fusion plasma, and a first side outer wall and a second side outer wall extending in a direction away from the front outer wall,

the outer flow path includes a front outer flow path through which the first fluid flows along the front outer wall, an outer inflow path through which the first fluid flows along the first side outer wall toward the front outer flow path, and an outer outflow path through which the first fluid flows along the second side outer wall toward the double discharge pipe from the front outer flow path, and

the inner wall includes a front inner wall facing the front outer wall on a side opposite to the fusion plasma.

(Item 13)

The blanket for the fusion reactor according to item 11, wherein the inner wall further includes a first side inner wall and a second side inner wall extending in a direction away from the front inner wall, and a rear inner wall facing the front inner wall on a side opposite to the front outer wall, and

the inner flow path further includes a front inner flow path through which the second fluid flows between the front inner wall and the rear inner wall, an inner inflow path through which the second fluid flows along the first side inner wall toward the front inner flow path, and an inner outflow path through which the second fluid flows along the second side inner wall in a direction away from the front inner flow path.

(Item 14)

The blanket for the fusion reactor according to item 13, wherein the outer wall further includes a third side outer wall and a fourth side outer wall that are arranged to face each other with the front outer wall, the first side outer wall, the second side outer wall, the front inner wall, the first side inner wall, the second side inner wall, and the rear inner wall interposed therebetween.

(Item 15)

The blanket for the fusion reactor according to item 14, wherein the third side outer wall and the fourth side outer wall are connected to each of the front outer wall, the first side outer wall, the second side outer wall, the front inner wall, the first side inner wall, the second side inner wall, and the rear inner wall.

(Item 16)

The blanket for the fusion reactor according to Item 11, wherein a flow path cross-sectional area of the front outer flow path is smaller than a flow path cross-sectional area of the outer inflow path.

(Item 17)

The blanket for the fusion reactor according to item 11, wherein a flow path cross-sectional area of the outer outflow path is smaller than a flow path cross-sectional area of the outer inflow path.

(Item 18)

The blanket for the fusion reactor according to item 13, wherein a flow path cross-sectional area of the front outer flow path is smaller than a flow path cross-sectional area of the front inner flow path.

(Item 19)

The blanket for the fusion reactor according to item 11 further comprising: a support structure that supports the first side outer wall.

(Item 20)

The blanket for the fusion reactor according to item 13, wherein the outer wall further includes a rear outer wall facing the rear inner wall on a side opposite to the front inner wall, and

the outer flow path further includes a rear outer flow path through which the first fluid flows along the rear outer wall.

### Explanation of References

10...fusion reactor, 12...vacuum vessel, 28...blanket, 36...support structure, 40...outer wall, 40a...front outer wall, 40b...rear outer wall, 40c...first side outer wall, 40d...second side outer wall, 42...inner wall, 42a...front inner wall, 42b...rear inner wall, 42c...first side inner wall, 42d...second side inner wall, 44...supply pipe, 46...discharge pipe, 48...outer flow path, 48a...front outer flow path, 48b...rear outer flow path, 48c...outer inflow path, 48d...outer outflow path, 50...inner flow path, 50a...first heating chamber, 50b...second heating chamber, 50c...inner inflow path, 50d...inner outflow path, 52...flow divider, 54...outer pipe, 56...inner pipe.

What is claimed is:

1. A blanket for a fusion reactor comprising:
an outer wall including a front outer wall facing a fusion plasma;
an inner wall provided inside the outer wall and including a front inner wall facing the front outer wall on a side opposite to the fusion plasma;
an outer flow path formed between the outer wall and the inner wall and through which a first fluid flows; and
an inner flow path formed inside the inner wall and through which a second fluid identical to the first fluid flows.

2. The blanket for the fusion reactor according to claim 1, further comprising:
a double discharge pipe having an outer pipe through which the first fluid discharged from the outer flow path flows, and an inner pipe through which the second fluid discharged from the inner flow path flows.

3. A blanket for a fusion reactor comprising:
an outer wall;
an inner wall provided inside the outer wall;
an outer flow path formed between the outer wall and the inner wall and through which a first fluid flows;
an inner flow path formed inside the inner wall and through which a second fluid flows; and
a double discharge pipe having an outer pipe through which the first fluid discharged from the outer flow path flows, and an inner pipe through which the second fluid discharged from the inner flow path flows.

4. The blanket for the fusion reactor according to claim 2, wherein
during operation of the fusion reactor, a temperature of the second fluid flowing through the double discharge pipe is higher than a temperature of the first fluid flowing through the double discharge pipe.

5. The blanket for the fusion reactor according to claim 1, wherein
a volume of the inner flow path is larger than a volume of the outer flow path.

6. The blanket for the fusion reactor according to claim 1, further comprising:
a supply pipe to which a fluid is supplied; and
a flow divider that divides the fluid supplied from the supply pipe into the first fluid toward the outer flow path and the second fluid toward the inner flow path.

7. The blanket for the fusion reactor according to claim 6, wherein
the flow divider is configured to divide the fluid such that a flow rate of the first fluid becomes greater than a flow rate of the second fluid.

8. The blanket for the fusion reactor according to claim 6, wherein
the fluid includes lithium.

9. The blanket for the fusion reactor according to claim 6, wherein
the fluid is a liquid metal.

10. The blanket for the fusion reactor according to claim 1, wherein
at least one of the outer wall or the inner wall includes silicon carbide.

11. The blanket for the fusion reactor according to claim 1, wherein
the outer wall further includes a first side outer wall and a second side outer wall extending in a direction away from the front outer wall, and
the outer flow path includes a front outer flow path through which the first fluid flows along the front outer wall, an outer inflow path through which the first fluid flows along the first side outer wall toward the front outer flow path, and an outer outflow path through which the first fluid flows along the second side outer wall in a direction away from the front outer flow path.

12. The blanket for the fusion reactor according to claim 3, wherein
the outer wall includes a front outer wall facing a fusion plasma, and a first side outer wall and a second side outer wall extending in a direction away from the front outer wall,
the outer flow path includes a front outer flow path through which the first fluid flows along the front outer wall, an outer inflow path through which the first fluid flows along the first side outer wall toward the front outer flow path, and an outer outflow path through which the first fluid flows along the second side outer wall toward the double discharge pipe from the front outer flow path, and
the inner wall includes a front inner wall facing the front outer wall on a side opposite to the fusion plasma.

13. The blanket for the fusion reactor according to claim 11, wherein
the inner wall further includes a first side inner wall and a second side inner wall extending in a direction away from the front inner wall, and a rear inner wall facing the front inner wall on a side opposite to the front outer wall, and
the inner flow path further includes a front inner flow path through which the second fluid flows between the front inner wall and the rear inner wall, an inner inflow path through which the second fluid flows along the first side inner wall toward the front inner flow path, and an inner outflow path through which the second fluid flows along the second side inner wall in a direction away from the front inner flow path.

14. The blanket for the fusion reactor according to claim 13, wherein
the outer wall further includes a third side outer wall and a fourth side outer wall that are arranged to face each other with the front outer wall, the first side outer wall, the second side outer wall, the front inner wall, the first side inner wall, the second side inner wall, and the rear inner wall interposed therebetween.

15. The blanket for the fusion reactor according to claim 14, wherein
the third side outer wall and the fourth side outer wall are connected to each of the front outer wall, the first side outer wall, the second side outer wall, the front inner wall, the first side inner wall, the second side inner wall, and the rear inner wall.

16. The blanket for the fusion reactor according to claim 11, wherein
a flow path cross-sectional area of the front outer flow path is smaller than a flow path cross-sectional area of the outer inflow path.

17. The blanket for the fusion reactor according to claim 11, wherein
a flow path cross-sectional area of the outer outflow path is smaller than a flow path cross-sectional area of the outer inflow path.

18. The blanket for the fusion reactor according to claim 13, wherein
a flow path cross-sectional area of the front outer flow path is smaller than a flow path cross-sectional area of the front inner flow path.

19. The blanket for the fusion reactor according to claim 11, further comprising:
a support structure that supports the first side outer wall.

20. The blanket for the fusion reactor according to claim 13, wherein
the outer wall further includes a rear outer wall facing the rear inner wall on a side opposite to the front inner wall, and
the outer flow path further includes a rear outer flow path through which the first fluid flows along the rear outer wall.
